(19) United States
(12) Patent Application Publication
(10) Pub. No.: US 2023/0259517 A1
(43) Pub. Date: Aug. 17, 2023

(54) BUSINESS APPLICATION PROCESS AND SYSTEM

(71) Applicant: Yeroosha, Inc., Miami, FL (US)

(72) Inventors: Elizabeth Lipkowitz, Westmount (CA); Mitchell Rankin, Miami, FL (US)

(21) Appl. No.: 17/672,786

(22) Filed: Feb. 16, 2022

(51) Int. Cl. G06F 16/25; G06F 16/2457; G06F 16/22; G06F 40/174

(52) U.S. Cl. CPC G06F 16/252; G06F 16/24573; G06F 16/2291; G06F 40/174

(57) ABSTRACT

A method, system, and non-transitory computer-readable medium for facilitating business application processing over a communications network is disclosed. The system includes an operating system-level virtualization platform configured for hosting and executing containers, and for dynamically scaling said containers according to user demand for said containers, including a first container for accepting input data from a user, creating a first data structure and creating a second data structure, a second container for selecting a business and determining which container to execute, based on a desired business application submission method, a third container for generating an API call based on an API specification for a remote server, wherein the API call includes the second data structure, and executing said API call, a fourth container for automatically preparing a business form based on the second data structure, and a fifth container for initiating a call between the user and an agent.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to business processes executed via a computing device, and more specifically, the claim subject matter relates to a process for facilitating business application processes.

### BACKGROUND

On a daily basis, millions of business applications are prepared, filled out, processed and managed. In this document, the term “business application” refers to a standard business form or document that is prepared with questions deemed relevant for a business purpose. A business application may be a job application that is provided by an employer and filled out by a potential employee for the purpose of being considered for a job. A business application may also be a mortgage application that is provided by a bank and filled out by a consumer for the purpose of being considered for a mortgage. A business application further be an insurance application that is provided by an insurance company and filled out by a potential consumer for the purpose of applying for life insurance. There are many and various business applications and they have become ubiquitous in the business landscape today, especially given the rise of the use of the Internet. One of the problems associated with conventional business applications involves the difficulties connecting the people administering the applications, such as business form administrators, human resource managers, agents, and brokers, with consumers, as well as the complicated application process. As a result of these wide-felt issues, consumers and professionals engaging with business applications face many uphill battles. In many cases, consumers are burdened out of the gate with an overwhelming number of options to consider, ranging not only from which individual agent, broker, or company to choose, but also which selectins to choose in the business application. If the consumer is able to discern which options are best for them, they are then subject to a daunting application process that takes them through various representatives and other professionals, and that requires due diligence and affirmative actions on the consumer's part—an overall lengthy and undesirable process. Agents and others operating as professionals in the space experience the opposite side of the same burdens. The burdens of obtaining applicants and thereafter maintaining them throughout the application process while making the process as smooth and easy for the potential customer are perhaps the largest and most widely felt burdens in the industry. In short, many people don't use business applications because the process of applying is lengthy and cumbersome.

In addition to these shortfalls, agents and brokers must navigate through this portion of the process in manner that keeps the potential customer engaged and interested, a task that is difficult considered the complex nature of the business application process. Once the business application process is started, the customer is often bombarded with calls and emails, requests for documentation, request for data, and often required to meet a slew of other requirements that may vary from company to company. While customers come in hoping for a quick and easy process, the process can be delayed for many reasons. For the agent, maintaining communication and seeing the process through is equally as difficult and the scattered nature of the process, requiring consumers to cause the potential customer to act on the requests above, and do so honestly, in order to see the process through to final disposition.

As a result of the substantial shortcomings in the process for preparing, filing, and processing business applications, the need exists for a centralized and streamlined method of doing so. Specifically, the need exists for a centralized method and system for facilitating the business application process.

### SUMMARY

A method, system, and non-transitory computer-readable medium for facilitating business application processing over a communications network is disclosed. The system comprises a database configured for storing a plurality of user records and data structures; a web server communicably connected to the communications network and to the database, the web server including an operating system-level virtualization platform configured for hosting and executing a plurality of containers, and for dynamically scaling said plurality of containers according to user demand for said plurality of containers, wherein said plurality of containers includes: 1) a first container executing on said platform, the first container configured for accepting, via the communications network, input data from a user, storing said input data in one or more user records in the database, creating a first data structure composed of strings, attributes of strings, dependencies between strings, and hierarchies between strings, encoding changes to the first data structure based on the input data, populating the first data structure based on the input data, storing the first data structure in a first memory location, creating a second data structure composed of strings, attributes of strings, dependencies between strings, and hierarchies between strings, encoding changes to the second data structure based on the first data structure, populating the second data structure by mapping data from the first data structure, and storing the second data structure in a second memory location; 2) a second container executing on said platform, the second container configured for selecting a business, based on the input data, to which a business application shall be submitted, and determining which of the following containers to execute, based on a desired business application submission method for said business that was selected; 3) a third container executing on said platform, the third container configured for generating an application programming interface (API) call based on an API specification for a remote server, wherein the API call includes the second data structure, and executing said API call to the remote server via the communications network; 4) a fourth container executing on said platform, the fourth container configured for automatically preparing a business form based on the second data structure, and transmitting said business form to a business form administrator via the communications network; 5) a fifth container executing on said platform, the fifth container configured for initiating, over the communications network, a call between the user and an agent, such that the agent aids in completing a business form based on the second data structure, and transmitting said business form to a business form administrator via the communications network.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a system for facilitating the business application process over a communications network, in accordance with one embodiment.

FIG. 2 is a block diagram showing the data flow of the process for facilitating the business application process over a communications network, according to one embodiment.

FIG. 3 is a flow chart depicting the general control flow of a process for facilitating the business application process over a communications network, according to one embodiment.

FIG. 4 is a block diagram depicting a system including an example computing system and other computing devices.

FIG. 5 is a block diagram of a data structure used in the claimed embodiments.

FIG. 6 is a block diagram showing the components of a system for facilitating the business application process over a communications network, according to one embodiment.

### DETAILED DESCRIPTION OF THE DRAWINGS

The disclosed embodiments improve upon the issues identified within the prior art by facilitating the process for completing business applications. Specifically, the disclosed embodiments improve over the prior art by centralizing and streamlining the business application process from the initial stage of customer engagement to final disposition using an automated process executed over a communications network such as the Internet or the public switched telephone network (PSTN). This prevents customers and agents from having to be in one another's physical presence to complete the process, and additionally allows agents to complete the process from anywhere they may find themselves with a wireless internet or cellular connection.

The disclosed embodiments further improve over the prior art by streamlining the business application process, as mentioned above. This is done by reducing the complexity of the business application process through the use of conditional logic that operates to allow agents to ask the fewest questions while continuing to cover the broad scope of business applications. This improvement is further evidenced by the inclusion of automated processes such as interactive voice response (IVR), data scraping, e-sign services, etc.

The disclosed embodiments further improve upon the prior art by significantly reducing the time spent on the business application process and maintaining direct and exclusive communication between the agent and their potential customer. Using the automated process listed herein, customers can expect significantly shorter wait times in completing a business application process than presently is permitted by the conventional business application processes.

The disclosed embodiments further improve over the prior art by improving the functioning of the claimed computer itself. In particular, as discussed above, the claimed process allows the computer to use to less memory than required for conventional document formats, results in faster computation time (i.e., generating data structures, encoding changes to the structures, and populating them) without expending large amounts of processing time, disk storage and user experience, as occurs with conventional document formats. These are also improvements in the technology of business application form processing. The claimed embodiments are an innovation in computer technology, namely business application form processing, which in this case reflects both an improvement in the functioning of the computer and an improvement in another technology.

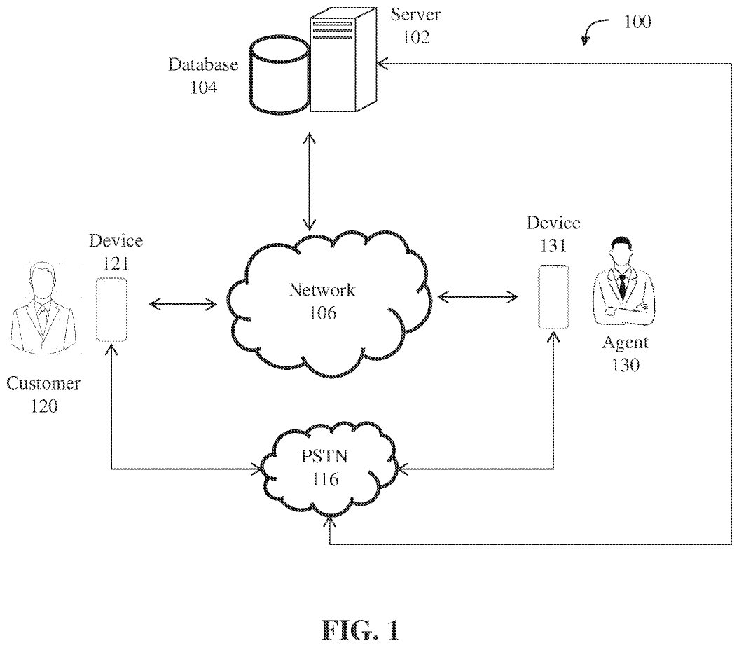

Referring now to the drawing figures in which like reference designators refer to like elements, there is shown in FIG. 1 an illustration of a block diagram showing the network architecture of a system 100 for facilitating the business application process. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating the business application process.

FIG. 1 includes mobile computing devices 121 and 131, which may be smart phones, mobile phones, tablet computers, handheld computers, laptops, or the like. In addition, FIG. 1 includes customer 120 and agent 130, which are the corresponding users to mobile devices 121 and 131, respectively. Customer 121 is a consumer seeking to use a business application, such as an application for employment, an application for a mortgage or an application for a life insurance policy. Agent 130 is a person that is tasked with administering the business application, such as a human resource manager that administers applications for employment, a mortgage broker that administers applications for a mortgage or an insurance broker that administers applications for a life insurance policy. Agent 130 may be a licensed agent with a company or an individual licensed broker. FIG. 1 also shows a server 102 and database or repository 106, which may be a relational database comprising a Structure Query Language (SQL) database stored in a SQL server. The repository 104 serves data from a database during the course of operation of the disclosed embodiments. Database 104 may be distributed over one or more nodes or locations that are connected via network 106.

The database 104 may include a user or customer record for each customer 120 and an agent record for each agent 130. A user or customer record may include contact/identifying information for a person (username, first name, middle name, last name, address, telephone number, email address, etc.), healthcare and biological information for the person (pre-existing conditions, familial health history, present and past prescriptions, drug use, occupation, sex, gender expression, etc.), electronic payment information for the user, sales transaction data associated with the user, etc. A customer record may also include current location data about the user, a unique identifier for the user or other relevant data for the customer. A customer record may further include demographic data for the user, such as age, income data, race, color, marital status, etc. An agent record may include similar information about the agent with the addition that this record may include the agent's employer, licenses, specializations, states of licensure, etc. A customer record may also include input data which may include data that is used by a company in the business application process, such as the customer's age, the customer's gender, the customer's smoker status, and the customer's personal information.

Customer records and agent records may include sales transaction data, which may include one or more product/service identifiers (such as SKUs), one or more product/service amounts, buyer contact/identifying information, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

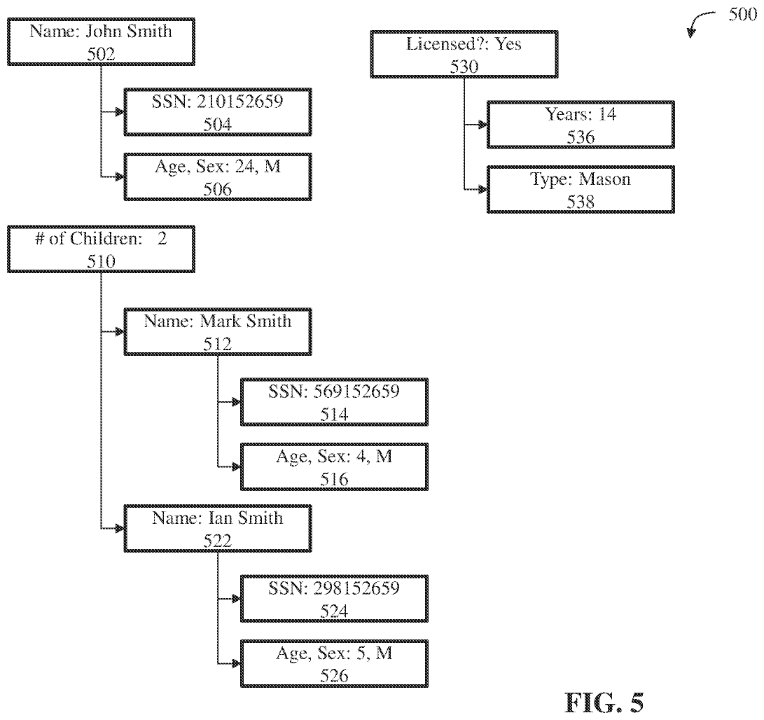

Database 104 may further store data structures especially configured for storing business application data. The data structure is a business application data organization, management, and storage format that enables efficient access and modification. More precisely, the data structure is a collection of business application data values, the relationships among them, and the functions or operations that can be applied to the data, i.e., it is an algebraic structure about data. The algebraic structure consists of a set of values, a collection of operations that may be executed on the values, and a finite set of identities that the operations must satisfy. FIG. 5 provides a more detailed account of the data structure. Business application data may include all of the data found in a customer or user record above.

FIG. 1 shows an embodiment wherein networked computing devices 121 and 131 interact with server 102 and database 104 over a network 106. It should be noted that although FIG. 1 shows only the networked computers 121, 131, and 102, the system of the disclosed embodiments supports any number of networked computing devices connected via network 106. Further, server 102, and units 121 and 131 may include program logic such as computer programs, mobile applications, executable files, or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 121 or 131. Further, server 102 and its functionality, according to a preferred embodiment, can be realized in a centralized fashion in one computer system or in a distributed fashion wherein different elements are spread across several interconnected computer systems.

FIG. 5 is a block diagram of a data structure 500 (such as the data structure stored in the database 104 above) used in the claimed embodiments. Namely, the data structure 500 is created in steps 310, 312 below. Recall that a data structure is composed of strings, attributes of strings, dependencies between strings, and hierarchies between strings. A string is a sequence of characters, either as a literal constant or as a variable. The length of a string may be fixed or variable. A string may be considered as a data type and is often implemented as an array data structure of bytes (or words) that stores a sequence of elements, typically characters, using some character encoding. A hierarchy is an arrangement of items (in this case, strings) in which the items are represented as being superior to, subordinate to, or “at the same level as” one another. A hierarchy links items vertically to an item's immediate superior or to one of the item's subordinates. Each block in FIG. 5 shows an attribute-value pair, such as the attribute-value pair in block 502 with attribute “Name” (attribute) and value “John Smith”.

FIG. 5 shows an example wherein the block 502 with string value “John Smith” has the attribute “Name” and therefore this string represents the name of the customer. The block 504 has the attribute “social security number” and the string value “210152659” while block 506 has the attribute “age, sex” and the string value “24, M” (i.e., blocks 504, 506 hold the social security number, age, and sex of the customer). The vertical connection between the blocks 504, 506 and blocks 502 indicate that blocks 504, 506 are subordinate to, and must be associated with, a superior block 502. This is part of the hierarchical structure of the data structure. Note that the number of blocks subordinate to superior block 502 is predefined as two. That is, for each superior block 502, there will always be a predefined number (two) subordinate blocks, namely, the social security number and age, sex blocks. Other superior blocks may have a different predefined number of subordinate blocks. The blocks 502, 504, 506 hold the basic information for a “person.”

Continuing, the block 510 holds the attribute “# of Children,” which answers the question of how many children the customer has. Since the block 510 has the numerical value 2 (i.e., the customer has two children), there are necessarily two sets of blocks corresponding to the two “persons.” The first set of blocks 512, 514, 516 hold the basic information for the first “person” named “Mark Smith” and the second set of blocks 522, 524, 526 hold the basic information for the second “person” named “Ian Smith.” The vertical connection between the blocks 512, 522 and block 510 indicate that blocks 512, 522 are subordinate to, and must be associated with, a superior block, such as block 510. This is part of the hierarchical structure of the data structure. Note, however, that the number of “persons” (or set of blocks) under the block 510 is dependent on the numerical value of block 510, which is 2. Since block 510 has the value 2, there are necessarily two “persons” (or two sets of blocks) subordinate to block 510. In this way, the number of “persons” subordinate to block 510 is dependent on the value of the block 510. This defines the dependencies that may be shown in the data structure. The vertical connection between the blocks 514, 516 and block 512 indicate that blocks 514, 516 are subordinate to, and must be associated with, a superior block, such as block 512. In this case, the number of blocks subordinate to block 512 is predefined as 2, because each “name” block (512) has 2 subordinate blocks (the SSN block and the age, sex block.

FIG. 5 also shows the block 530 with value “Yes” and therefore this string represents that the customer is a licensed technician. The block 536 holds the value for the number of years the customer is licensed and the block 538 holds the type of license held by the customer (a mason, as in a stone mason). The vertical connection between the blocks 536, 538 and blocks 530 indicate that blocks 536, 538 are subordinate to, and must be associated with, a superior “Licensed?” attribute string, such as block 530. This is part of the hierarchical structure of the data structure. But also, the existence of the blocks 536, 538 in the data structure is dependent on the value of block 530. Since block 530 has the value “Yes”, the blocks 536, 538 necessarily exist. But if block 530 had the value “No”, the blocks 536, 538 would not exist. In this way, the existence of blocks 536, 538 are dependent on the value of the block 530. This defines the dependencies that may be shown in the data structure. Also, the number of blocks subordinate to block 530 is predefined as 2, because each “yes” block (530) has 2 subordinate blocks (the years block and the type block). Other superior blocks may have a different predefined number of subordinate blocks.

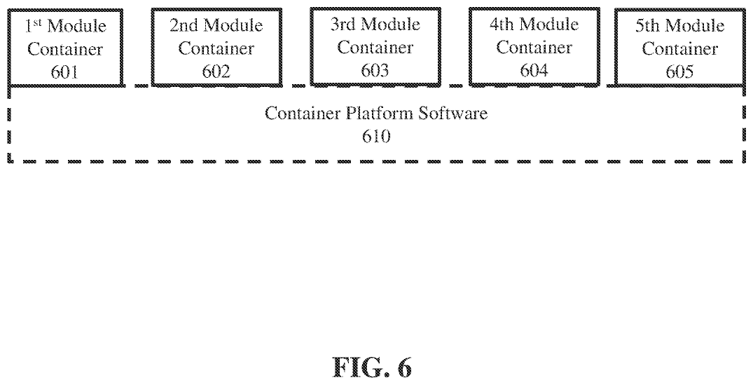

FIG. 6 is a block diagram showing the components of the system 100 for facilitating the business application process over a communications network, according to one embodiment. FIG. 6 shows that a first module is deployed on the server 102 as a container 601, a second module is deployed on the server 102 as a container 602, a third module is deployed on the server 102 as a container 603, a fourth module deployed on the server 102 as a container 604, and a fifth module deployed on the server 102 as a container 605. The containers are executed on a container platform 610 deployed on the server 102. Container platform 610 may be a subset of, or a modular component of, the software executed by server 102 in the course of facilitating the business application process over a communications network.

A container is a standard unit of software that packages up code and all its dependencies, so the application runs quickly and reliably from one computing environment to another. A container image is a lightweight, standalone, executable package of software that includes everything needed to run an application: code, runtime, system tools, configuration files, system libraries and settings. Container images become containers at runtime. Available for most commercially available operating systems, containerized software will always run the same, regardless of the infrastructure. Containers isolate software from its environment and ensure that it works uniformly despite differences for instance between development and staging. Containers share the machine's (i.e., the computer on which the container is executing) operating system kernel and therefore do not require an operating system per application, leading to higher server efficiency and reducing server and licensing costs.

The containers 601-605 operate on a platform as a service (PaaS) 610 that uses operating system-level (OS-level) virtualization on which containers execute. The PaaS can package an application and its dependencies in a virtual container that can run on any operating system. This enables the application to run in a variety of locations, such as on-premises, in public or private cloud. Because containers are lightweight, a single server or virtual machine can run several containers simultaneously. OS-level virtualization is an operating system paradigm in which the kernel allows the existence of multiple isolated user space instances.

Container orchestration is the automation of the operational effort required to run containerized workloads and services. Container orchestration includes items needed to manage a container's lifecycle, including provisioning, deployment, scaling (up and down), networking, and load balancing. Because containers are lightweight and ephemeral by nature, running them in production can quickly become a massive effort. A containerized application might translate into operating hundreds or thousands of containers, especially when building and operating any large-scale system. This can introduce significant complexity if managed manually. Container orchestration makes the operational complexity manageable because it provides a declarative way of automating the work.

As shown in FIG. 6, the containers 601-605 execute on the container platform software 610. Among other things, the container platform software 610 includes container orchestration routines that manage provisioning, deployment, scaling (up and down), networking, and load balancing. Scaling is the act of handling a growing or decreasing amount of work placed on the containers by adding or subtracting resources to the system. The container platform software 610 executes dynamic scaling as follows. As the demand among consumers for a particular container increases, the container platform software 610 increases the instances of said container to handle the load. Therefore, as more consumers are requesting container 601, the container platform software 610 creates and increases the instances of container 601 to handle the load. As the demand among consumers for a particular container decreases, the container platform software 610 decreases the instances of said container to free up resources. Thus, as fewer consumers are requesting container 601, the container platform software 610 decommissions or deallocates instances of container 601 to free up resources. The same scaling processes occur for containers 602-605.

The step of dynamically scaling said plurality of containers according to user demand for said plurality of containers operates as follows. The software evaluates user demand for each of the containers. If demand for any particular container increases over a predefined threshold, 610 reacts by creating one or more additional instances of said particular container. If demand for any particular container decreases below a predefined threshold, 610 reacts by deallocating one or more instances of said particular container. The steps above are executed repeatedly. User demand is defined as the amount of demand made by users for each container. The amount of demand is a number of demands for a container made by a user. The first module is demanded or requested by users when the system 100 is accessed by a user wanting to make a business application. The second module is demanded or requested by users when the user beings to provide answers to the questions posed by the second module. The third, fourth and fifth modules are demanded or requested by users when the second module routes the users to said third, fourth and fifth modules (see description of second module below).

In another embodiment, dynamic scaling is executed using an algorithm that determines which containers need to scale up or down by applying several rules. These rules examine various aspects of the system such as how many instances of each container type are currently instantiated, how long each container of each type has been in existence, how much each container of each type is being used, historic demand for each container of each type, the current performance of each container of each type, the operational cost of each container of each type, current user demand, etc. Historic demand is defined as the amount of demand made by users for each container for a particular time period, such as a particular weekday between 5 pm and 9 pm. The amount of demand is a number of demands for a container made by a user. Historic demand, which may be stored in database 104, tells you how many containers of each type are typically in demand during a particular time period. A particular time period may be, for example, November 13 between 5-6 pm, or Thursdays from 1-2 pm, or Wednesday through Friday from 9 am-10 am.

In one embodiment, dynamic scaling is executed based on user demand and historic demand for each container of each type. In this embodiment, the software scales the containers up and down based on user demand, as described above. In addition, the software evaluates historic demand for a particular time period for each of the containers. If historic demand for any particular container for a particular time period is greater than the current number of instances of said container, 610 reacts by creating one or more additional instances of said particular container until the current number of instances matches historic demand for said particular time period. If historic demand for any particular container for a particular time period is less than the current number of instances of said container, 610 reacts by deallocating one or more instances of said particular container (assuming said instances are not currently interfacing with a customer) until the current number of instances matches historic demand for said particular time period. The steps above are executed repeatedly. A particular time period may include a time of day (or range), a day of the week (or range), a particular day of the month (or range) and a particular month (or range), or any combination of the above.

Load balancing refers to the process of distributing the load initiated by consumers over a set of containers, with the aim of making their overall processing more efficient. Load balancing optimizes the response time and avoid unevenly overloading some containers while other containers are left idle. The container platform software 610 executes dynamic load balancing as follows. The container platform software 610 distributes the number of requests for each container as evenly as possible among the multiple instances of said container, so as not to overload any one container or leave any container idle.

FIG. 6 shows the first module is deployed on the server 102 as a container 601. The first module is an intake module configured for administering questions to a customer that solicits business application data that is stored in a record, such as a customer record. FIG. 6 shows the second module is deployed on the server 102 as a container 602. The second module is a module configured for selecting one of the following modules (the third, fourth or fifth modules, 603, 604, 605) based on the business application data collected by the first module 601 above.

FIG. 6 shows the third module is deployed on the server 102 as a container 603. The third module is an API access module configured for making a business application for the customer via an API. FIG. 6 shows the fourth module is deployed on the server 102 as a container 604. The fourth module is a form module configured for making a business application for the customer by completing and electronically submitting forms. FIG. 6 that the fifth module deployed on the server 102 as a container 605. The fifth module is a call module configured for initiating a phone call between an agent and the customer.

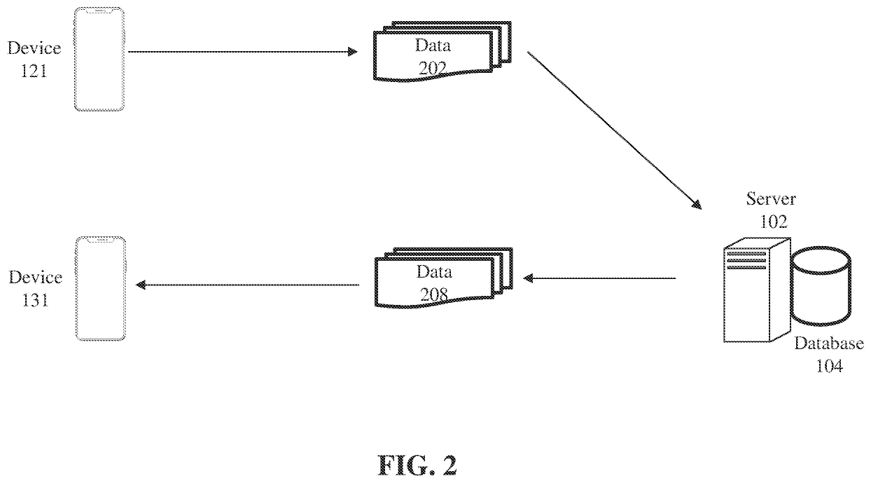

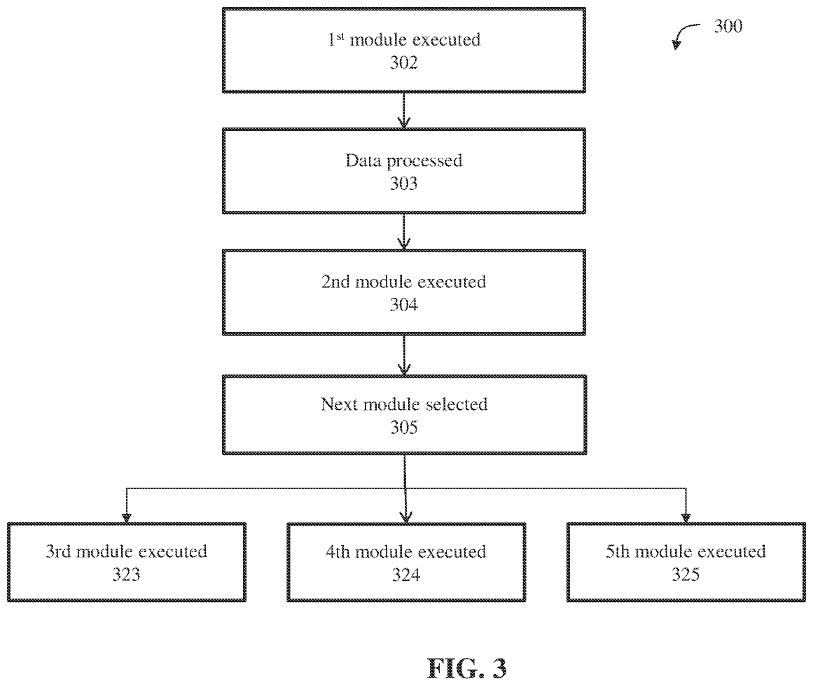

The process for facilitating the business application process over a communications network will now be described with reference to FIGS. 2-3 below. FIGS. 2-3 respectively depict the data flow and control flow of the process for facilitating the business application process over a communications network 106, according to one embodiment. The process of the disclosed embodiments begins with step 302 (see flowchart 300, FIG. 3), wherein the first module deployed on the server 102 as a container 601 is executed. Via the first module, customer 120 initially engages or interacts with server 102. Engagement may consist of an interaction by the customer 120 with a graphical user interface on a mobile application or a website, or the like. In step 302, the user inputs into a mobile application, a web form, a website, etc. input data (defined above) or any data that may be stored in a customer record. The data input by the customer in step 302 (otherwise known as “input data”) may include answers to questions posed in a web form. The first module is configured for receiving said data via data packet 202 over network 106. Data packet 202 may be made up of various types of data, including but not limited to voice, text, image, etc. Server 102 stores the input data in a customer record in database 104.

In the next step 303, the data collected in the previous step is processed as follows. In step 303, the server 102 creates a first data structure, as described more fully in FIG. 5. The server 102 encodes changes to the first data structure based on the input data and the further data, and the server 102 populates the first data structure based on the input data and the further data. That is, the server 102 creates all of the attribute-value pairs of each block (such as blocks 502-538 in FIG. 5), creates the hierarchies between blocks (such as the superior-subordinate relationship between blocks 502 and 504), and all of the dependencies between the strings (such as the dependency between block 510 and blocks 512, 522). Then, the server populates the values for each attribute-value pair in the first data structure using the input data and the further data. The server 102 stores the first data structure in a first memory location. In one embodiment, the server 102 encrypts the first data structure before it is stored in the first memory location, so that any sensitive customer data may be secure from viewing by unauthorized parties. Server 102 may also store any data input into the form into the relevant customer record in database 104.

In one embodiment, one or more of the elements of the data structure may be stored in an array. In another embodiment, dependencies where the number of dependent blocks may be variable, such as the dependency between block 510 and blocks 512, 522, are represented using linked lists. Note that although FIG. 5 shows only blocks 512, 522 depending from block 510, any number of blocks may depend from block 510, since the customer may have any number of children. In another embodiment, hierarchies where the number of subordinate blocks may be variable, such as the superior-subordinate relationship between block 502 and blocks 504, 506, are represented using linked lists. Note that although Fig, 5 shows only blocks 504, 506 subordinate to block 502, any number of blocks may be subordinate to block 502. In another embodiment, one or more of the elements of the data structure may be stored in an object data structure.

It should be noted that conventionally, the storage of business application data is stored in conventional document formats, such as Portable Document Format (PDF). The problem with using such conventional document storage techniques is the large amount of data necessary to store business application data, which often includes complex metadata such as hierarchies, dependencies, attributes, etc. The Portable Document Format required a large amount of storage space because this format includes data formatting for items such as vector graphics, raster images, interactive elements such as annotations, layers, rich media (including video content), and three-dimensional objects using U3D or PRC. The Portable Document Format also includes a header, objects, index table, and a footer. Consequently, the Portable Document Format requires a large amount of storage space to store what is sometimes a small amount of data. The advantage of the use of the first data structure is that it allows the computer to use to less memory than required for conventional document formats, such as PDF. This results in faster computation time (i.e., generating the first data structure, encoding changes to the structure, and populating it) without expending large amounts of processing time, disk storage and user experience, as occurs with conventional document formats.

Subsequently, further in step 303, the server 102 creates a second data structure, as described more fully in FIG. 5. The server 102 encodes changes to the second data structure based on the first data structure, and the server 102 populates the second data structure based on the first data structure. That is, the server 102 creates all of the attribute-value pairs of each block, creates the hierarchies between blocks, and all of the dependencies between the strings. Then, the server populates the values for each attribute-value pair in the second data structure by mapping the data in the first data structure to the second data structure. The server 102 stores the second data structure in a second memory location. In one embodiment, the server 102 encrypts the second data structure before it is stored in the second memory location, so that any sensitive customer data may be secure from viewing by unauthorized parties. If the first data structure was encrypted, then the processor unencrypts the first data structure before it is further used herein.

In one embodiment, the second data structure is created using a particular format that is distinct from the format of the first data structure. This is because the second data structure is used to complete the business application which may have a different format than the format used for the first data structure. In said different format, the attribute-value pairs may be different, the dependencies may be different, and the hierarchies may be different. Therefore, a mapping function must be utilized. A mapping function is a mathematical algorithm that maps data from the format of the first data structure to the format of the second data structure. In this embodiment, the step of encoding changes to the second data structure based on the first data structure may include creating the hierarchies between blocks (in accordance with the second data structure format), and all of the dependencies between the strings (in accordance with the second data structure format). In this embodiment, the step of populating the values for each attribute-value pair in the second data structure includes utilizing the mapping function that maps data from the first data structure to the second data structure.

The mapping function may include conversion functions wherein source data from the first structure is read and converted into a different format for storage into the target data in the second data structure. For example, value data in the first data structure may be height data in feet and inches. In this example, the mapping function includes a conversion function wherein the height data is converted from feet/inches into meters, and the converted data is stored in the second data structure. In another example, the dependencies, such as the dependency between block 510 and blocks 512, 522, may be represented using linked lists in the first data structure but may be represented using arrays in the second data structure. Therefore, the mapping function maps data from the linked lists of the first data structure to the arrays of the second data structure. In another example, hierarchies, such as the superior-subordinate relationship between block 502 and blocks 504, 506, may be represented using linked lists in the first data structure but may be represented using arrays in the second data structure. Therefore, the mapping function maps data from the linked lists of the first data structure to the arrays of the second data structure. In another example, the dependencies, such as the dependency between block 510 and blocks 512, 522, may be represented as hierarchies in the second data structure. Therefore, the mapping function maps data from the dependencies of the first data structure to the hierarchies of the second data structure.

In the next step 304, the second module deployed on the server 102 as a container 602 is executed. The second module determines which of the third, fourth and fifth modules to execute. If the server 102 determines that the third module is appropriate, then step 323 is executed, if the server 102 determines that the fourth module is appropriate, then step 324 is executed, and if the server 102 determines that the fifth module is appropriate, then step 325 is executed. Various and different criteria may be used to determine which of the third, fourth and fifth modules to execute. In one example, the server uses the input data collected in the step above to determine which of said modules to execute.

In one embodiment, based on the input data collected from the customer, the second module selects a business to which the business application is submitted. For example, if a customer intends to submit a mortgage application, and the customer is a first-time home buyer (according to the input data), then the second module may select a particular bank that services first-time home buyers. In another example, if a customer intends to submit a life insurance application, and the customer is over 80 years old (according to the input data), then the second module may select a particular insurance provider that services elderly customers over 80 years old. Therefore, the second module has access to a list of businesses (stored in database 104), wherein said list shows a correspondence between each business and the attributes and/or values of input data that correspond to said business. For example, the list may include a particular bank, and associated with said bank is an indicator that it services first-time home buyers. In another example, the list may include a particular insurance provider, and associated with said insurance provider is an indicator that it services customers over 80 years old. Said list also indicates the method by which each business accepts business applications, otherwise known as its desired business application submission method. The second module compares the input data to said list and determines which of the businesses on that list best matches the customer's input data, based on the correspondence described above. Subsequently, based on the business selected, the second module determines which of the third, fourth and fifth modules to execute.

Certain businesses (which accept the business application being prepared by server 102) may require API access as their desired business application submission method, certain businesses may require a business form (such as in PDF format) transmitted electronically as their desired business application submission method, and certain businesses may require a live agent (on a phone call with the customer) to prepare a business form transmitted electronically as their desired business application submission method. Therefore, different business may have different desired business application submission methods. In this embodiment, the second module accesses the list described above to determine the selected business's desired business application submission method. Said desired business application submission method determines which of the third, fourth and fifth modules to execute.

In step 323, the third module deployed on the server 102 as a container 603 is executed. In step 323, server 102 makes an API call via network 106 to a remote server of the business selected by the second module, wherein that API call includes the data from the second data structure. The API call conforms to the API specification for the remote server of the selected business. The remote server automatically reads the data from the second data structure, thereby receiving the customer's business application. The remote server may automatically respond with an acknowledgement of receipt of the business application. An application programming interface (API) is a connection between computer programs, i.e., software interface, that offers a service. An API specification is a standard that describes how to use the interface. An API call is the process of an application submitting a request to an API and that API retrieving the requested data or performing the desired action and responding.

In step 324, the fourth module deployed on the server 102 as a container 604 is executed. In step 324, server 102 completes an electronic form and submits it electronically to the business selected by the second module. The third module automatically completes a form, such as a web form (based on the data in the second data structure) and submits said form to a business form administrator at the selected business. In one embodiment, this step comprises the server 102 generating a script in a scripting language, such as Selenium IDE, which script is then transmitted via network 106 to a remote server that executes that script. Said script is configured to automatically copy certain data from the second data structure, enters said data into said web form and presses the relevant button on said web form that submits the form. A business form administrator is a person at the selected business whose job it is to review the business application of the customer and continue to process said business application for the purpose for which it was intended. For example, a business form administrator at a bank may be a person whose job it is to review mortgage applications and continue to process said mortgage application for the purpose of providing a mortgage to the customer, assuming the customer qualifies.

In step 325, the fifth module deployed on the server 102 as a container 605 is executed. In step 325, server 102 initiates a call, over the communications network 106 or PSTN 116, between the customer 120 and the particular agent 130. In one embodiment, the call may be a VoIP call over network 106. Also in step 325, the server 102 transmits, over the communications network, a secure form (via data packet 208 or similar) to the particular agent 130, wherein the form includes said input data and allows the agent to enter further data into the form. Further, the server 102 provides, over the communications network, an automated process that facilitates completion of the form. The automated process may include one or more of a bot, a web service or conditional logic that facilitates completion of the form by reducing an amount of data that must be input by the agent 130 into the form. Using conditional logic, the agent is guided to ask only the questions necessary until all fields are completed as required to complete the application for this use case. Questions are presented to the agent in a sequence that is designed to facilitate the flow of information. During said call, the agent solicits further data from the customer, which the agent inputs into the secure web form. When completed, the form is submitted electronically, via network 106, to a business form administrator at the business selected by the second module.

The use of conditional logic (or conditional statements, conditional expressions, and conditional constructs) includes the use of a programming language that performs different computations or actions depending on whether a Boolean condition evaluates to true or false. As a result, the automated process that facilitates completion of the form eliminates questions that must be answered by the agent and/or customer and/or eliminates blanks that must be filled in by the agent and/or customer. For example, one question may ask whether the customer is married. The second question may ask how long the customer has been married. The automated process that facilitates completion of the form may detect that the answer to the first question is “no” or negative, and therefore eliminate the requirement that the second question be asked. In this way, the automated process that facilitates completion of the form eliminates questions that must be answered by the agent and/or customer and/or eliminates blanks that must be filled in by the agent and/or customer, thereby streamlining the process.

Note that steps 302-325 include limitations that amount to significantly more than the mathematical operation recited in the step of creating the first data structure. There are several additional limitations recited in steps 302-325 besides the mathematical operation of creating the first data structure (creating a first data structure composed of strings, attributes of strings, dependencies between strings, and hierarchies between strings, encoding changes to the first data structure based on the input data and the further data, populating the first data structure based on the input data and the further data). The steps 302-325 also recite the steps of storing the first data structure in a first memory location and creating a second data structure and storing the second data structure in a second memory location. The steps 302-325 also recite the additional steps of creating a second data structure, encoding changes to the second data structure based on the first data structure, populating the second data structure by mapping data from the first data structure. The steps 302-325 also recite data structure encrypting steps. These additional steps tie the mathematical operation (creating the first data structure) to the processor's ability to complete business applications using previously entered data. These steps add meaningful limitations to the abstract idea of creating the first data structure and therefore add significantly more to the abstract idea than mere computer implementation. The steps 302-325, when taken as a whole, do not simply describe the creation of a first data structure via a mathematical operation and storing data, but combines the steps of creating the first data structure with the steps for creating a second data structure, encoding changes to the second data structure based on the first data structure, and populating the second data structure by mapping data from the first data structure. By this, steps 302-325 go beyond the mere concept of simply storing, retrieving, and combining data using a computer.

Finally, viewing the elements of steps 302-325 as an ordered combination, the steps recited in addition to the creation of the first data structure improve the functioning of the claimed computer itself. In particular, as discussed above, the process with the first and second data structures allows the computer to use to less memory than required for conventional document formats, results in faster computation time (i.e., generating the first and second data structures, encoding changes to the structures and populating them) without expending large amounts of processing time, disk storage and user experience, as occurs with conventional document formats. These are also improvements in the technology of business application processing. The processes of steps 302-325 are not merely limiting the abstract idea to a computer environment by simply performing the idea via a computer (i.e., not merely performing routine data receipt and storage or mathematical operations on a computer), but rather is an innovation in computer technology, namely business application processing, which in this case reflects both an improvement in the functioning of the computer and an improvement in another technology. Taking all the additional elements individually, and in combination, the steps 302-325 as a whole amount to significantly more than the abstract idea of creating a first data structure.

In one embodiment, the term encoding refers to the action of transforming a dataset into code, i.e., the action of converting (characters, symbols or any representation of an object) into a digital form. For example, the step of encoding changes to the first data structure based on the input data and the further data may comprise transforming character data (such as ASCII characters) into numerical or hexadecimal value that are stored in the first data structure. In another example, the step of encoding changes to the first data structure may comprise converting or mapping the dependencies between strings and hierarchies between strings in the input data and further data into numerical or hexadecimal value that are stored in the first data structure. In one embodiment, the step of encoding changes to the second data structure based on the first data structure may include mapping the hierarchies between blocks from the format of the first data structure to the format of the second data structure, as well as converting or mapping the hierarchies between strings into numerical or hexadecimal value that are stored in the second data structure. Also, the step of encoding changes to the second data structure based on the first data structure may include mapping the dependencies between strings from the format of the first data structure to the format of the second data structure, as well as converting or mapping the dependencies between strings into numerical or hexadecimal value that are stored in the second data structure.

, and all of the dependencies between the strings (in accordance with the second data structure format). In this embodiment, the step of populating the values for each attribute-value pair in the second data structure includes utilizing the mapping function that maps data from the first data structure to the second data structure.

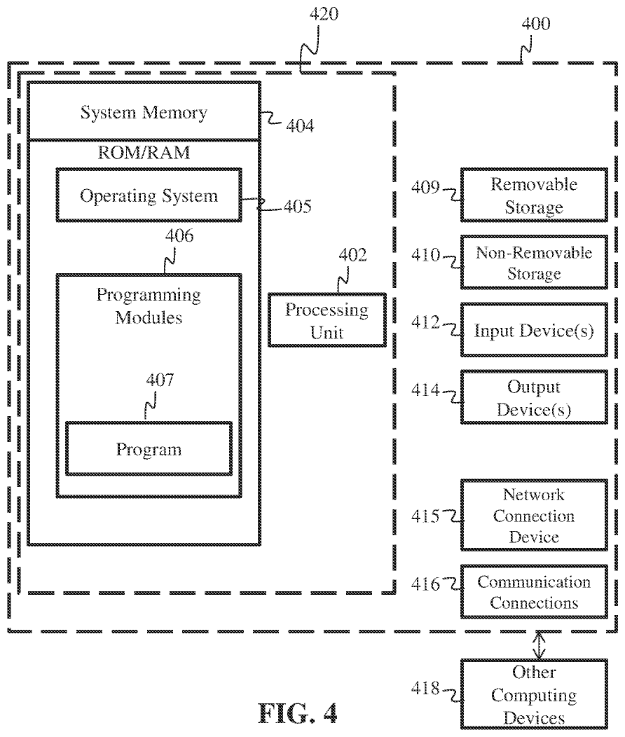

FIG. 4 is a block diagram of a system including an example computing device 400 and other computing devices. Consistent with the embodiments described herein, the aforementioned actions performed by 121, 131, or 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of 121, 131, 102. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system for facilitating business application processing over a communications network, the computing system comprising:
a database configured for storing a plurality of user records and data structures;
a web server communicably connected to the communications network and to the database, the web server including an operating system-level virtualization platform configured for hosting and executing a plurality of containers, and for dynamically scaling said plurality of containers according to user demand for said plurality of containers, wherein said plurality of containers includes:
1) a first container executing on said platform, the first container configured for accepting, via the communications network, input data from a user, storing said input data in one or more user records in the database, creating a first data structure composed of strings, attributes of strings, dependencies between strings, and hierarchies between strings, encoding changes to the first data structure based on the input data, populating the first data structure based on the input data, storing the first data structure in a first memory location, creating a second data structure composed of strings, attributes of strings, dependencies between strings, and hierarchies between strings, encoding changes to the second data structure based on the first data structure, populating the second data structure by mapping data from the first data structure, and storing the second data structure in a second memory location; and
2) a second container executing on said platform, the second container configured for selecting a business, based on the input data, to which a business application shall be submitted, and determining which of the following containers to execute, based on a desired business application submission method for said business that was selected;
3) a remote server of the business, wherein the API call includes the second data structure, and executing said API call to the remote server via the communications network;
4) a fourth container executing on said platform, the fourth container configured for automatically preparing a business form based on the second data structure, and transmitting said business form to a business form administrator of the business via the communications network;
5) a fifth container executing on said platform, the fifth container configured for initiating, over the communications network, a call between the user and an agent, such that the agent aids in completing a business form based on the second data structure, and transmitting said business form to a business form administrator of the business via the communications network.

2. The system of claim 1, wherein the step of accepting, via the communications network, input data from a user further comprises providing a graphical user interface on a web site.

3. The system of claim 2, wherein the step of initiating, over the communications network, a call between the user and an agent further comprises initiating a call, over the public switched telephone network between the user and the agent.

4. The system of claim 3, wherein the step of storing the first data structure in a first memory location further comprises encrypting the first data structure before it is stored in the first memory location, and wherein the step of storing the second data structure in a second memory location further comprises encrypting the second data structure before it is stored in the second memory location.

5. A method implemented on a server for facilitating business application processing over a communications network, comprising the steps of:
providing a database configured for storing a plurality of user records and data structures;
providing a web server communicably connected to the communications network and to the database, the web server including an operating system-level virtualization platform configured for hosting and executing a plurality of containers, and for dynamically scaling said plurality of containers according to user demand for said plurality of containers, wherein said plurality of containers includes:
1) a first container executing on said platform, the first container configured for accepting, via the communications network, input data from a user, storing said input data in one or more user records in the database, creating a first data structure composed of strings, attributes of strings, dependencies between strings, and hierarchies between strings, encoding changes to the first data structure based on the input data, populating the first data structure based on the input data, storing the first data structure in a first memory location, creating a second data structure composed of strings, attributes of strings, dependencies between strings, and hierarchies between strings, encoding changes to the second data structure based on the first data structure, populating the second data structure by mapping data from the first data structure, and storing the second data structure in a second memory location;
2) a second container executing on said platform, the second container configured for selecting a business, based on the input data, to which a business application shall be submitted, and determining which of the following containers to execute, based on a desired business application submission method for said business that was selected;
3) a third container executing on said platform, the third container configured for generating an applicaiton programming interface (API) call based on an API specification for a remote server of the business, wherein the API call includes the second data structure, and executing said API call to the remote server via the communications network;
4) a fourth container executing on said platform, the fourth container configured for automatically preparing a business form based on the second data structure, and transmitting said business form to a business form administrator of the business via the communications network;
5) a fifth container executing on said platform, the fifth container configured for initiating, over the communications network, a call between the user and an agent, such that the agent aids in completing a business form based on the second data structure, and transmitting said business form to a business form administrator of the business via the communications network.

6. The method of claim 5, wherein the step of accepting, via the communications network, input data from a user further comprises providing a graphical user interface on a web site.

7. The method of claim 6, wherein the step of initiating, over the communications network, a call between the user and an agent further comprises initiating a call, over the public switched telephone network between the user and the agent.

8. The method of claim 7, wherein the step of storing the first data structure in a first memory location further comprises encrypting the first data structure before it is stored in the first memory location, and wherein the step of storing the second data structure in a second memory location further comprises encrypting the second data structure before it is stored in the second memory location.

9. A non-transitory computer-readable medium with instructions stored thereon, that when executed by a processor, perform the steps comprising:
providing a database configured for storing a plurality of user records and data structures;
providing a web server communicably connected to the communications network and to the database, the web server including an operating system-level virtualization platform configured for hosting and executing a plurality of containers, and for dynamically scaling said plurality of containers according to user demand and historic demand for said plurality of containers, wherein said plurality of containers includes:
1) a first container executing on said platform, the first container configured for accepting, via the communications network, input data from a user, storing said input data in one or more user records in the database, creating a first data structure composed of strings, attributes of strings, dependencies between strings, and hierarchies between strings, encoding changes to the first data structure based on the input data, populating the first data structure based on the input data, storing the first data structure in a first memory location, creating a second data structure composed of strings, attributes of strings, dependencies between strings, and hierarchies between strings, encoding changes to the second data structure based on the first data structure, populating the second data structure by mapping data from the first data structure, and storing the second data structure in a second memory location;
2) a second container executing on said platform, the second container configured for selecting a business, based on the input data, to which a business application shall be submitted, and determining which of the following containers to execute, based on a desired business application submission method for said business that was selected;
3) a remote server of the business, wherein the API call includes the second data structure, and executing said API call to the remote server via the communications network;
4) a fourth container executing on said platform, the fourth container configured for automatically preparing a business form based on the second data structure, and transmitting said business form to a business form administrator of the business via the communications network;
5) a fifth container executing on said platform, the fifth container configured for initiating, over the communications network, a call between the user and an agent, such that the agent aids in completing a business form based on the second data structure, and transmitting said business form to a business form administrator of the business via the communications network.

10. The non-transitory computer-readable medium of claim 9, wherein the step of accepting, via the communications network, input data from a user further comprises providing a graphical user interface on a web site.

11. The non-transitory computer-readable medium of claim 10, wherein the step of initiating, over the communications network, a call between the user and an agent further comprises initiating a call, over the public switched telephone network between the user and the agent.

12. The non-transitory computer-readable medium of claim 11, wherein the step of storing the first data structure in a first memory location further comprises encrypting the first data structure before it is stored in the first memory location, and wherein the step of storing the second data structure in a second memory location further comprises encrypting the second data structure before it is stored in the second memory location.

13. The non-transitory computer-readable medium of claim 11, wherein historic demand
